(19) United States
(12) Patent Application Publication
(10) Pub. No.: US 2025/0162863 A1
(43) Pub. Date: May 22, 2025

(54) DRY HYDROGEN PRODUCTION METHOD FROM SLUDGE

(71) Applicants: SK GAS CO., LTD., Seongnam-si, Gyeonggi-do (KR); EWHA UNIVERSITY - INDUSTRY COLLABORATION FOUNDATION, Seoul (KR)

(72) Inventors: Woo Jae KIM, Seoul (KR); Hye Min JUNG, Cheonan-si, Chungcheongnam-do (KR); Ji Eun PARK, Hwaseong-si, Gyeonggi-do (KR); Ung Gi HONG, Seongnam-si, Gyeonggi-do (KR); Hyeong Chan AHN, Seongnam-si, Gyeonggi-do (KR); Tae Hyeop KIM, Seongnam-si, Gyeonggi-do (KR)

(73) Assignees: SK GAS CO., LTD., Seongnam-si, Gyeonggi-do (KR); EWHA UNIVERSITY - INDUSTRY COLLABORATION FOUNDATION, Seoul (KR)

(21) Appl. No.: 18/729,033

(22) PCT Filed: Jan. 16, 2023
(86) PCT No.: PCT/KR2023/000716

§ 371 Date: Jul. 15, 2024

(30) Foreign Application Priority Data
Jan. 14, 2022 (KR) 10-2022-0005952

(51) Int. Cl. C01B 3/02; C01D 7/07

(52) U.S. Cl. CPC C01B 3/02; C01D 7/07

(57) ABSTRACT

A dry hydrogen production method includes drying sludge; producing a sludge mixture by mixing the dried sludge with an aqueous hydroxide solution and then drying a mixture or mixing the dried sludge with hydroxide powder; introducing the sludge mixture into a reactor; producing a reaction product by heating the sludge mixture in the reactor without supplying water or vapor; separating the reaction product into a gas effluent and a solid effluent through gas-solid separation; and producing a gas product from the gas effluent.

### CROSS-REFERENCE TO PRIOR APPLICATIONS

This Application is a National State Patent Application of PCT International Application No. PCT/KR2023/000716 (filed on Jan. 16, 2023), which claims priority to Korean Patent Application No. 10-2022-0005952 (filed on Jan. 14, 2022), which are all hereby incorporated by reference in their entirety.

### BACKGROUND

The present disclosure relates to a method for producing hydrogen from dried sludge without the supply of vapor or water.

The increasing concern over greenhouse gas emissions and global warming has heightened the demand for developing and disseminating new renewable energy sources to replace fossil fuels. Hydrogen, considered as a clean energy option, is gaining attention due to its abundance on Earth in various forms such as fossil fuels, biomass, and water. Efficient and environmentally friendly hydrogen production methods are crucial for its use as a fuel.

Hydrogen production methods include traditional fossil fuel reforming techniques and renewable methods using biomass and water. Traditional methods include steam reforming, partial oxidation, autothermal reforming, and gasification.

Renewable methods are categorized into thermochemical and biological processes using biomass, while water-based methods include electrolysis, thermal decomposition, and photolysis.

Currently, approximately 96% of hydrogen is produced through fossil fuel reforming, with biomass-based production remaining minimal. Despite this, biomass is recognized as a clean energy source due to its carbon cycle impact, it is necessary to investigate more efficient hydrogen production methods from biomass for industrial applications.

There is growing interest in re-evaluating food waste (sludge) as an energy resource rather than viewing it solely as a nuisance waste, though effective solution has not yet been found.

Specifically, U.S. Pat. No. 4,822,497 discusses a pressure vessel acting as a reactor for oxidizing harmful substances in supercritical water, facing challenges related to salt formation and removal under reaction conditions.

According to “Gasification of waste to produce low-BTU gas by Molten Salt Technique,” published in the Journal of the Institution of Engineers India (1989), by Y. Raja, significant biomass vaporization occurs in dry salt melts, yet carbon monoxide production remains a concern. Further steps such as a shift converter for hydrogen production are recommended, with challenges in preventing charcoal or coke formation during conversion in dry salt melts.

DE 202 20 307 U1 discloses a device for handling a fluid material in supercritical water. In this case, the device is formed of a cylindrical reactor equipped with pressure pipes for a starting material supply line and a product discharge line. Here, the product discharge line is formed as an upright pipe. In this case, this pipe protrudes into a reaction chamber from above, and terminates at one-third of a reactor height, with a bottom outlet installed at the bottom of the reactor, which is located at its narrowest section. It has valves arranged for a cooler and continuous (or intermittent) bottom discharge.

U.S. Pat. No. 6,878,479 B2 discloses a device for directly converting fuel into electrical energy. Here, an electrochemical cell in which a melted electrolyte is present each time has a bipolar tilted structure, and is arranged so that electrical resistance between cells is minimal.

According to “Comparison of the Effects of the addition of NaOH on the decomposition of 2-chlorophenol and phenol in supercritical water and under supercritical water oxidation conditions,” J. Supercritical Fluids, vol. 24, page 239 to 250, 2002, by G. Lee, T. Nunoura, Y. Matsumura, and K. Yamamoto, it is known that the effects of NaOH on the decomposition of an organic compound should be taken into account when determining optimized reaction conditions and optimized reactor design.

According to “Bubble points of the Systems isopropanol-water, isopropanol-water-sodium acetate and isopropanol-water-sodium oleate at high pressure,” Fluid Phase Equilibria, vol. 244, page 78 to 85, 2006, by M. D. Bermejo, A. Martin, L. J. Florusse, C. J. Peters, and M. J. Cocero, it is known that oxidation in supercritical water represents an effective technique for the decomposition of organic waste with high yields.

Korean Patent Publication KR2002-0055346 discloses a method and device for producing methanol using a biomass raw material. To be more specific, the patent discloses a methanol production device using a biomass raw material, which includes a hydrogen gas supply means to continuously supply hydrogen gas required for reaction from gases produced by gasifying biomass.

Korean Patent No. KR10-2138897 relates to a biomass fuel processing system for a hydrogen fuel cell vehicle. More particularly, it discloses a biomass fuel processing system for a hydrogen fuel cell vehicle that includes a filter to maintain reaction conditions.

### SUMMARY

While various methods for conventional food waste (sludge) treatment have been proposed, this disclosure aims to offer an efficient and effective approach. One embodiment introduces a clean technology for hydrogen production from dried sludge without the need for additional steam or water, thereby generating hydrogen as a clean energy source without unnecessary harmful by-products.

A preferred method for dry hydrogen production from sludge, includes steps of,
producing a sludge mixture by mixing the dried sludge with an aqueous hydroxide solution and then drying a mixture, or mixing the dried sludge with hydroxide powder;
introducing the sludge mixture into a reactor;
producing reaction products by heating the sludge mixture in the reactor without supplying water or vapor;
separating the reaction products into a gas effluent and a solid effluent through gas-solid separation; and
producing a gas product from the gas effluent.

The hydroxide may be alkali or alkaline earth hydroxide.

The alkali hydroxide may be sodium hydroxide.

The step of producing the gas product may be performed using a gas separation means.

The dry hydrogen production method may further include a step of producing a solid product from the solid effluent.

The solid product may include unreacted hydroxide, and alkali or alkaline earth carbonate.

The alkali carbonate may be sodium carbonate.

The step of producing the solid product from the solid effluent may include steps of dissolving the solid effluent in water, separating unreacted sludge, removing heavy metal, and separating the solid effluent into the solid product.

The step of separating the unreacted sludge and the step of removing the heavy metal may be performed independently of each other using a filter.

The step of separating the solid effluent into the solid product may separate it into a hydroxide solution, solid hydroxide, or solid carbonate using a difference in solubility

The dry hydrogen production method may further include a step of recycling the unreacted hydroxide in the solid product to the step of producing the sludge mixture.

The method may further include a step of recycling at least one of the hydroxide solution and the solid hydroxide to the step of producing the sludge mixture.

At least one of the gas effluent and the solid effluent may be used as a fuel for heating the sludge mixture.

The hydroxide may be converted into carbonate using carbon dioxide produced from the heat source for heating the sludge mixture.

A sludge: hydroxide weight ratio may be 1:1 to 3.

The step (4) of producing the reaction product may be performed at 200 to 600° C.

A carrier gas of the dry hydrogen production method may be air or nitrogen.

The dry hydrogen production technology described in this disclosure generates hydrogen from dried sludge without using vapor or water, offering clean energy production with minimal device load, low energy consumption, and no unnecessary harmful by-products

### BRIEF DESCRIPTION OF THE DRAWINGS

FIG. 1 schematically shows a reactor used in the present disclosure.

FIG. 2 schematically shows the experiment result of a comparative example in which steam is supplied to dried sludge without NaOH.

FIG. 3 schematically shows the experiment result of a comparative example in which NaOH and steam are supplied to dried sludge.

FIG. 4 schematically shows the experiment result of an embodiment of the present disclosure in which air is used as a carrier gas, and water and steam are not supplied.

FIG. 5 schematically shows the experiment result of an embodiment of the present disclosure in which nitrogen is used as a carrier gas, and water and steam are not supplied.

FIG. 6 schematically shows the experiment result of an embodiment of the present disclosure in which nitrogen is used as a carrier gas, dried sludge and NaOH powder are mixed, and water and steam are not supplied.

### DETAILED DESCRIPTION

Preferably, a dry hydrogen production method from sludge according to the present disclosure includes steps of,
producing a sludge mixture by mixing the dried sludge with an aqueous hydroxide solution and then drying a mixture or mixing the dried sludge with hydroxide powder;
introducing the sludge mixture into a reactor;
producing a reaction product by heating the sludge mixture in the reactor without supplying water or vapor;
separating the reaction products into a gas effluent and a solid effluent through gas-solid separation; and
producing a gas product from the gas effluent.

Hereinafter, preferred embodiments of the present disclosure will be described with reference to the accompanying drawings. However, the present disclosure may be implemented in various ways without being limited to particular embodiments described herein.

In describing the embodiments, the same names and characters are used to designate the same components, and a duplicated description thereof will be omitted herein. Like reference numerals refer to like components throughout various figures. In the accompanying drawings, the sizes of components may be exaggerated for clarity of illustration.

In addition, the term “or” is intended to mean an inclusive “or” and not an exclusive “or.” That is, unless otherwise specified or the context clearly indicates otherwise, “X utilizes A or B” is intended to mean one of natural implicit substitutions. In other words, if X uses A; X uses B; or X uses both A and B, “X uses A or B” may be applied to these cases. Further, the term “and/or” as used herein should be understood to refer to and include all possible combinations of one or more of the related listed items.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In the present disclosure, the singular forms are intended to include the plural forms as well, unless the context clearly indicates otherwise.

A dry hydrogen production method from sludge according to the present disclosure is to produce clean hydrogen from dried sludge and hydroxide powder (obtained by drying aqueous hydroxide solution).

The sludge may include organic matter containing glucose, such as food waste.

The hydroxide may be a compound having a metal element and a negatively charged hydroxide ion (OH—). To be more specific, the hydroxide may include an alkali metal compound in which alkali metal is bonded to a hydroxide ion (OH—), or alkaline earth metal compound in which alkaline earth metal is bonded to a hydroxide ion (OH—). For example, the hydroxide may include at least one of potassium hydroxide (KOH), sodium hydroxide (NaOH), lithium hydroxide (LiOH), calcium hydroxide (Ca(OH)₂), and magnesium hydroxide (Mg(OH)₂). Further, according to an embodiment, one or more hydroxides may be used in combination. According to an embodiment, the hydroxide may be introduced into a reactor in the form of a dry powder or in the form of a solution with another solvent (e.g. water). The above description of the hydroxide is merely illustrative, and the present disclosure is not limited thereto.

In an embodiment of the present disclosure, it is more preferable that the alkali hydroxide is sodium hydroxide.

According to an embodiment of the present disclosure, a catalyst may be included. The catalyst may include a material that facilitates a gasification reaction into hydrogen by assisting the reaction of sludge and hydroxide. To be more specific, the catalyst may include at least one element selected from nickel (Ni) and iron (Fe). The catalyst may be mixed in advance with sludge and hydroxide and then introduced into the reactor. Further, the catalyst may be placed in an inorganic nanofiber structure such as silica, alumina, zirconia, or carbon.

Specifically, the dry hydrogen production method according to the present disclosure preferably includes,
a step (1) of drying sludge;
a step (2) of mixing the dried sludge with an aqueous hydroxide solution and drying it or mixing the dried sludge with hydroxide powder to prepare a sludge mixture;
a step (3) of introducing the sludge mixture into a reactor;
a step (4) of producing a reaction product by heating the mixture in the reactor without supplying water or vapor;
a step (5) of separating the reaction product into a gas effluent and a solid effluent through gas-solid separation; and
a step (6) of producing a gas product from the gas effluent.

The step (1) of drying the sludge is to dry the sludge washed to remove dirt or odors to a state that contains almost no moisture. The drying method will vary as will be apparent to those skilled in the art, and is not limited to a specific method.

Next, the step (2) is performed by mixing the dried sludge with the hydroxide powder to prepare the sludge mixture, or mixing the dried sludge with the aqueous hydroxide solution and drying it to provide the sludge mixture. The important features of the prior art are to maintain or supply moisture. However, in the present disclosure, the reaction is performed without the supply moisture. presence or additional supply of such moisture (water), so it is more effective in terms of energy efficiency or side reaction. A mixing means may mechanically mix the sludge, the hydroxide, and the catalyst as needed while rotating. Because it is a dry reaction, uniform mixing is especially important.

The mixing ratio of the sludge and hydroxide is preferably 1:1 to 3 by weight to ensure sufficient reaction.

The sludge mixture is then introduced into the reactor and reacted. Since the sludge mixture has no water, carrier gas is required throughout an overall process from a reactant to a product. The carrier gas is not limited to a specific gas within the scope of the purpose of the present disclosure, but is preferably air or nitrogen.

Further, in the present disclosure, there is no moisture (water) in the sludge or hydroxide, and the step (4) is performed to produce the reaction product by heating the mixture in the reactor without supplying water or vapor.

By heating the sludge mixture in the reactor above a preset temperature, the gasification reaction may occur. To be more specific, when the sludge mixture is placed in the reactor, the reactor may lead to the gasification reaction of the sludge by increasing a temperature inside the reactor above a preset temperature. Further, according to an embodiment, the reactor may maintain the above temperature conditions until no gasification reaction occurs in the sludge mixture. Here, the temperature of the reactor may be 200 to 600° C. based on standard pressure. Thus, the reactor may maintain temperature conditions at which carbonate and hydrogen are produced until the reaction is completed. The reactor according to another embodiment may be supplied with an additional sludge mixture before the gasification reaction of the sludge mixture is completed. In this case, the added sludge mixture may be supplied in an amount that may maintain reaction conditions in the reactor.

Here, the gasification reaction may be a chemical reaction that uses the sludge mixture containing sludge and hydroxide as a reactant and has hydrogen and carbonate as a product. To be more specific, the reactor may generate hydrogen in a gaseous state and carbonate in an ash state by heating the sludge mixture to cause the gasification reaction. Through the gasification reaction of the sludge mixture, hydrogen as a main product and carbonate as a by-product may be produced. Of course, it is obvious that impurities such as unreacted hydroxide may exist in the ash state.

The carbonate (M₂CO₃) may be produced through the gasification reaction of sludge and hydroxide. Here, the carbonate may include ionic crystals containing carbonate ions (CO₃²⁻). The carbonate preferably includes alkali or alkaline earth carbonate. For example, when sodium hydroxide is used as the hydroxide, hydrogen and sodium carbonate may be produced through the gasification reaction of sludge and sodium hydroxide.

The gas-solid separation step (5) is performed in which hydrogen-containing gas in the reaction product flows out from the top of the reactor to become the gas effluent and the ash-state solid containing carbonate flows out from the bottom of the reactor to become the solid effluent.

The gas effluent and solid effluent which have undergone the gas-solid separation are led to a subsequent process.

That is, the step (6) of producing a gas product (hydrogen) from the gas effluent is performed by a gas-gas separation means. The gas-gas separation is not particularly limited. According to the present disclosure, this is preferably performed using a gas separation means. The gas separation means may use a membrane, PSA, etc., but are not limited thereto as will be obvious to those skilled in the art. Since the gas effluent may contain a trace amount of solid product, the solid product may be removed from the gas effluent using a filter or the like. As such a means, a means obvious to those skilled in the art within the scope of the purpose of the present disclosure may be used.

Meanwhile, it is preferable that the dry hydrogen production method further includes a step (7) of producing a solid product (carbonate) from the solid effluent containing unreacted sludge, unreacted hydroxide, impurities, carbonate, etc.

The separation method is not particularly limited. Preferably, the step (7) of producing the solid product from the solid effluent includes a step (7-1) of dissolving the solid effluent in water, a step (7-2) of separating the unreacted sludge, a step (7-3) of removing heavy metal, and a step (7-4) of separating the solid effluent into the solid product.

It is preferable that the step (7-2) of separating the unreacted sludge and the step (7-3) of removing the heavy metal are performed independently of each other using the filter, but are not limited thereto as will be obvious to those skilled in the art.

The step (7-3) of removing the heavy metal is required due to environmental problems, and is especially intended to remove chromium and the like.

In the step (7-4) of separating the solid effluent into the solid product, it is preferable to separate it into a hydroxide solution, solid hydroxide, or solid carbonate using a difference in solubility caused by the step (7-1) of dissolving the solid effluent in water. For the separation, it may be performed by combining means of cooling, heating, cooling and heating the solution, and is not particularly limited within the scope of the purpose of the present disclosure.

Preferably, the dry hydrogen production method further includes a step (8 or 8-1) of recycling the unreacted hydroxide or its solution separated from the step (7) of producing the solid product from the solid effluent to the step (2) of producing the sludge mixture. The determination on whether to recycle may be made in consideration of economic aspects, and new hydroxide may be included to maintain the reaction conditions of the reactor.

Meanwhile, it is preferable to use either or both of the gas effluent and the solid effluent as the fuel of a heat source for heating the sludge mixture as needed.

Further, it is also possible to convert the hydroxide into carbonate using carbon dioxide produced from the heat source for heating the sludge mixture. The carbonate obtained in this way is desirable for increasing the yield of the overall process.

Hereinafter, the present disclosure will be described in more detail through specific examples of the present disclosure.

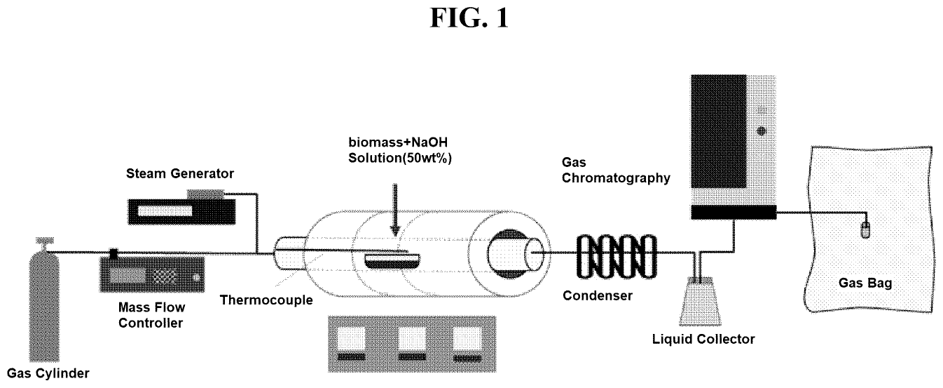

An experiment was conducted using the reactor as shown in FIG. 1.

### Comparative Example 1

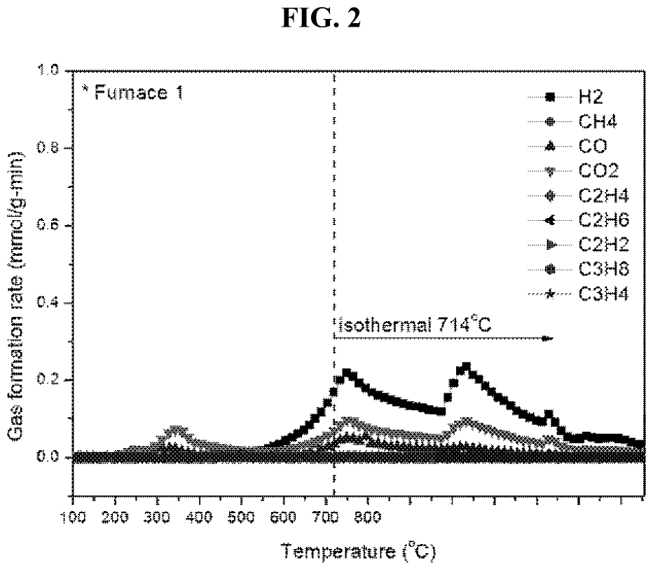

Nitrogen was supplied as a carrier gas at 50 cc/min, and the temperature in the reactor was maintained by increasing from 100° C. to 700° C. The experiment was conducted by supplying only 50 to 500 mg of dried sludge and water vapor (23 μl/min), and the results are shown in FIG. 2.

### Comparative Example 2

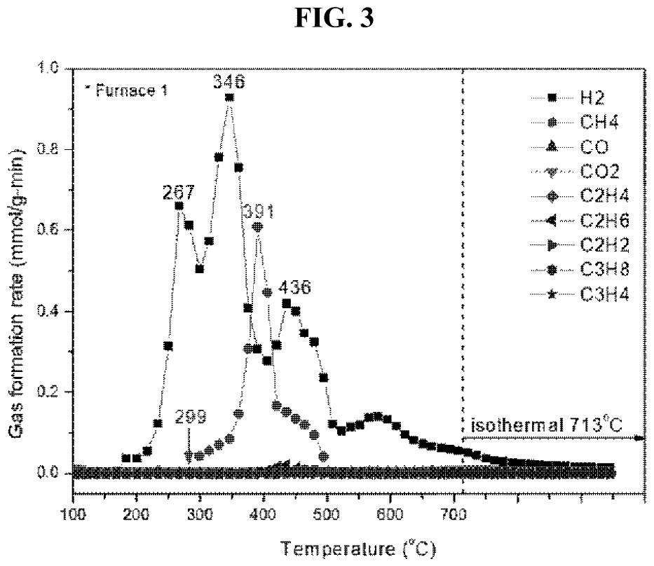

Except that 50 to 500 mg of (dry or wet) sludge and sodium hydroxide solution were mixed and dried so that the mixing ratio of sludge and sodium hydroxide was 1:3 by weight in Comparative Example 1 and supplied at 1 to 3 times the weight of the dried sludge, the experiment was conducted in the same manner as in Comparative Example 1 and hydrogen and by-products were measured as shown in FIG. 3.

### Embodiment 1

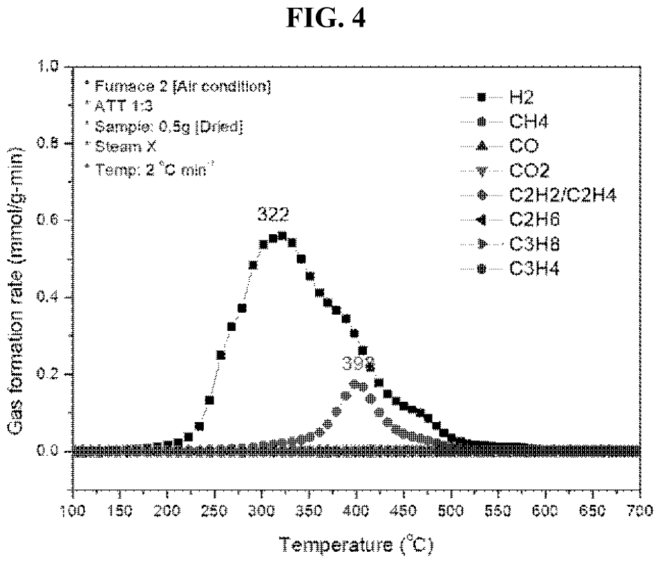

Air was supplied as the carrier gas at 50 cc/min, and the temperature in the reactor was maintained by increasing from 100° C. to 700° C. (Dry or wet) sludge and sodium hydroxide solution were mixed and dried so that the mixing ratio of 50 to 500 mg of sludge and sodium hydroxide was supplied at 1 to 3 times the weight of the dried sludge, the experiment was conducted without supplying water and water vapor, and then hydrogen and by-products were measured as shown in FIG. 4.

### Embodiment 2

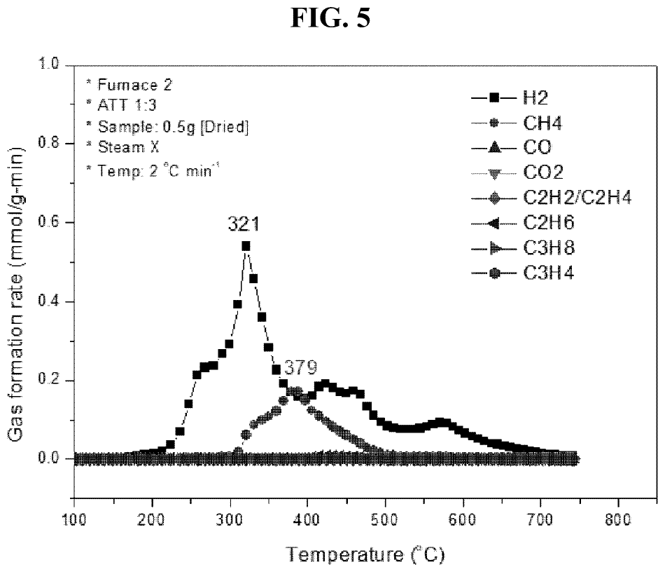

The experiment was conducted in the same manner as in Embodiment 1 except that nitrogen was used as the carrier gas in Embodiment 1, and hydrogen and by-products were measured as shown in FIG. 5.

### Embodiment 3

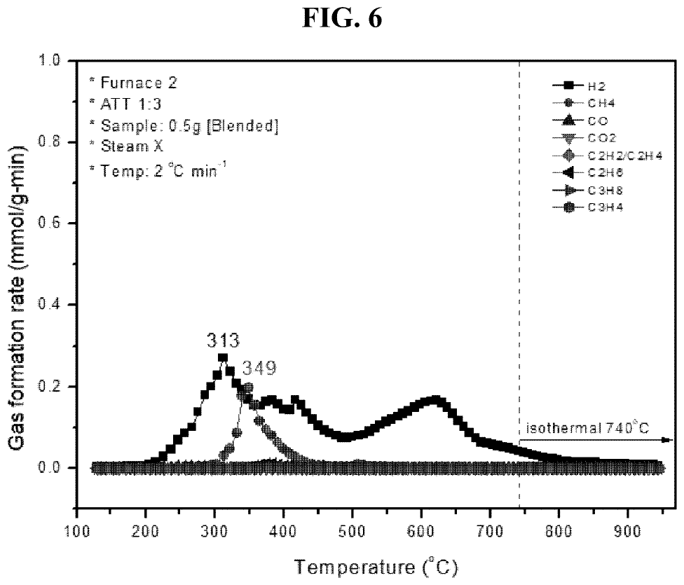

The experiment was conducted in the same manner as in Embodiment 2 except that the dried sludge and the NaOH powder were uniformly mixed in Embodiment 2, and hydrogen and by-products were measured as shown in FIG. 6.

As shown in FIG. 2, in the case of Comparative Example 1 in which sodium hydroxide is not supplied to the reactor and only water vapor is supplied, hydrogen production was low, the production start temperature for the product exceeded 700° C., and the production of by-products such as carbon dioxide was large, making it undesirable.

Further, as shown in FIG. 3, hydrogen production was possible within a desirable temperature range when using both NaOH and water vapor, but energy consumption was excessively high, making it undesirable.

Meanwhile, as shown in FIGS. 4 to 6, in Embodiments 1 to 3 according to the present disclosure, hydrogen production was possible at low temperature and was possible when the carrier gas was air and nitrogen. Since water or water vapor is not used, a load on the device is low and energy consumed is low, making it desirable.

Although the present disclosure has been described above with reference to preferred embodiments, it will understood by those skilled in the art that various modifications and changes may be made to the present disclosure without departing from the idea and scope of the present disclosure as set forth in the following claims.

The present disclosure is directed to a method for producing hydrogen from dried sludge without the supply of vapor or water.

1. A dry hydrogen production method, the method comprising steps of:
drying sludge;
producing a sludge mixture by mixing the dried sludge with an aqueous hydroxide solution and then drying a mixture or mixing the dried sludge with hydroxide powder;
introducing the sludge mixture into a reactor;
producing a reaction product by heating the sludge mixture in the reactor without supplying water or vapor;
separating the reaction product into a gas effluent and a solid effluent through gas-solid separation; and
producing a gas product from the gas effluent.

2. The method of claim 1, wherein the hydroxide is alkali or alkaline earth hydroxide.

3. The method of claim 2, wherein the alkali hydroxide is sodium hydroxide.

4. The method of claim 1, wherein the step of producing the gas product is performed using gas separation means.

5. The method of claim 1, further comprising a step of:
producing a solid product from the solid effluent.

6. The method of claim 5, wherein the solid product comprises unreacted hydroxide; and alkali or alkaline earth carbonate.

7. The method of claim 6, wherein the alkali carbonate is sodium carbonate.

8. The method of claim 5, wherein the step of producing the solid product from the solid effluent comprises steps of:
dissolving the solid effluent in water;
separating unreacted sludge;
removing heavy metal; and
separating the solid effluent into the solid product.

9. The method of claim 8, wherein the step of separating the unreacted sludge and the step of removing the heavy metal are performed independently of each other using a filter.

10. The method of claim 8, wherein the step of separating the solid effluent into the solid product separates it into a hydroxide solution, solid hydroxide, or solid carbonate using a difference in solubility

11. The method of claim 6, further comprising a step of:
recycling the unreacted hydroxide in the solid product to the step of producing the sludge mixture.

12. The method of claim 10, further comprising a step of:
recycling at least one of the hydroxide solution and the solid hydroxide to the step of producing the sludge mixture.

13. The method of claim 1, wherein at least one of the gas effluent and the solid effluent is used as a fuel of a heat source for heating the sludge mixture.

14. The method of claim 10, wherein the hydroxide is converted into carbonate using carbon dioxide produced from the heat source for heating the sludge mixture.

15. The method of claim 1, wherein a sludge: hydroxide weight ratio of the sludge mixture is 1:1 to 3.

16. The method of claim 1, wherein the step of producing the reaction product is performed at 200 to 600° C.

17. The method of claim 1, wherein a carrier gas is air or nitrogen.
